(19) United States
(12) Patent Application Publication
(10) Pub. No.: US 2026/0121326 A1
(43) Pub. Date: Apr. 30, 2026

(54) Electrical Connector

(71) Applicant: HANON SYSTEMS EFP DEUTSCHLAND GMBH, Bad Homburg v.d. Höhe (DE)

(72) Inventor: Dominik Lehner, Frankfurt am Main (DE)

(21) Appl. No.: 19/368,280

(22) Filed: Oct. 24, 2025

(30) Foreign Application Priority Data
Oct. 24, 2024 (DE) 102024210274.1
Apr. 14, 2025 (DE) 102025114576.8

(51) Int. Cl. H01R 13/11

(52) U.S. Cl. CPC H01R 13/113

(57) ABSTRACT

An electrical connector for electrically interconnecting a first electrical element and a second electrical element, the electrical connector extending from a first connector side to a second connector side, the electrical connector including a first conductor structure having a first spring portion and a first contact wing, a second conductor structure having a second spring portion and a second contact wing, the first spring portion and the second spring portion are configured to provide length compensation between the first connector side and the second connector side. Here, the first contact wing and the second contact wing are arranged opposite to each other and configured to form a receptacle for an external pin or sword of the second electrical element.

### CROSS-REFERENCE TO RELATED APPLICATION

This application is based on and claims the benefit of and priority to German Patent Application No. DE 10 2025 114 576.8, filed on Apr. 14, 2025, and German Patent Application No. DE 10 2024 210 274.1, filed on Oct. 24, 2024, the entire disclosure of each of which is incorporated herein by reference.

### TECHNICAL FIELD

Embodiments of the present invention refer to an electrical connector and to a method for manufacturing same. Preferred embodiments refer to a one-piece spring element that applies force to separate current contact surfaces.

### BACKGROUND

In many applications and also in automotive applications there is the need for electrically connecting different entities, like electrical components of an electric motor with the electrical interface of another entity, like the electronic control unit (ECU). In many cases, wires are used for electrically connecting the electrical components with each other. Wires have the advantage that they are flexible so that a displacement between the components is possible. In some applications the components are directly attached to each other, so that an electrical connection is directly formed between the respective contacts of the components. However, since a displacement, e.g., resulting from tolerances of components or thermal expansions lead to a (big) axial gap, a certain degree of flexibility between the contacts might be advantageous.

In the prior art some connectors are known which enable to overcome the axial gap between two components, e.g., the contact of a motor and an ECU.

FIGS. 5A and 5B show an electrical connector 60 comprising four elements, namely the electrical contacts on the first side 62, a spring 64 and another electrical contact 66 on the other side. Furthermore, the connector 60 comprises a housing 68.

The spring 64 is arranged so as to overcome an axial gap. For this, the spring 64 is compressible and extendable.

The first contact 62 comprises a plurality of flexible elements 62f which are configured to contact a contact pad (not shown) so as to form an electrical connection, e.g., to a contact pad of the ECU.

The second contact 66 comprises a receptacle 66r which is configured to receive an external pin or sword (not shown). Here, the receptacle 66r is configured to apply a force to the external pin or sword so that a secure connection results from this force. However, due to the arrangement of the spring 64, friction movement at the contact points can occur especially when the spring 66 is compressed and stretched. Therefore, there is the need for an improved approach.

### SUMMARY

It is the objective to provide a contact overcoming the axial gap without friction movement at the contact points.

Embodiments of the present invention provide an electrical connector for electrical interconnecting a first electrical element, like a contact pad, e.g., of an ECU, and a second electrical element. The electrical connector extends from first side (e.g., the side of the first electrical element) to a second side bracket (e.g., the side of the second electrical element). The electrical connector comprises
a first conductor structure comprising a first spring portion and a first contact wing;
a second contact structure comprising a second spring portion and a second contact wing.

The first spring portion and the second spring portion are configured to provide lengths compensation between the first connector side and the second connector side. The first contact wing and second contact wing are arranged opposite to each other and configured to form a receptacle for an external pin or sword of the second electrical element.

Embodiments of the present invention are based on the finding that by use of two conductor structures extending substantially along the direction from the first side to the second side, two functions can be ensured, namely lengths compensation between the first side and the second side and forming an electrical contact to a sword so that the sword is held by the two contact wings. Due to the elastic flexibility of a flexible portion of the conductor structure the lengths compensation is done. Since another portion of the conductor structure is bent so as to form a receptacle an external element like a sward can be fixed without causing friction or movement at the contact point. Beside the lengths compensation, the flexible portions, referred to as spring portions, ensure, for example when being compressed, that a sufficient force is applied to the contact points, especially the contact point at the first side.

According to an embodiment, the first conductor structure and the second conductor structure are integrally formed. This is advantageous since it reduces the complexity and, thus, the manufacturing effort. Consequently, each conductor structure may, for example, comprise a transition between the respective (first/second) spring portion and the respective (first/second) contact wing which represents the second side of the connector.

According to another embodiment, the first conductor structure and the second conductor structure are connected to each other so as to form a common layer, e.g., at a first side. This enables beneficially that the first conductor structure and the second conductor structure can be formed so as to a design where all functions are integrated into one part. The advantages are also present under the requirements of electrical power, temperature and oil.

According to embodiments, the first conductor structure and the second conductor structure extend from the common layer into a direction of the second side. According to embodiments, first conductor structure and the second conductor structure are arranged substantially in parallel to each other. For example, the symmetric arrangement of the first conductor structure and the second conductor structure enables that the axial movement is optimally damped without causing any deformation to the side. This further enables to avoid any friction art the contact point(s).

For example, the first spring portion and the second spring portion may have a meander-shape or an s-shape formed by a plurality of radiuses (sequence of loops). Due to the radiuses forming the s-elements, the elastic behavior of the spring portions is achieved. For example, one and a half s-elements (three radiuses) may form each of the first and second spring portions. The geometry, the number of s-elements, have an influence on the elasticity rate and the total amount of axial movement. According to another embodiment, the thickness of the layer forming the first and second conductor structure as well as the material itself have an influence on the elasticity rate. These design variants enable beneficially to design the electrical connector for different applications.

At the second side, a transition may be formed between the respective spring portion and the contact wing. Here, according to embodiments, the first contact wing and the second contact wing are bent to the inside. This enables beneficially to integrate the function of receiving the sword and of length compensation. Expressed in other words, this means a continuation of the first spring portion and the second spring portion being bent to the inside so as to form the first contact wing and the second contact wing and, thus, the receptacle.

According to embodiments, the first and the second contact wing are configured to provide a contact force to the pin or sword of the second element. The contact force is, for example, perpendicular to the axial direction along which the lengths compensation is done. Due to the contact force, a friction is caused so as to beneficially hold the sword (sandwiched) between the first and second wing.

According to further embodiments, the first and/or the second wings comprise a plurality of wing parts. These can be arranged side by side so that a plurality of contact points on each side between the sword (general: external element) and the respective wing part is formed.

According to an embodiment, the second connector side may comprise a limiter portion. This limiter portion may, for example, extend from the above-mentioned transition point to the side. For example, the limiter portion may be formed out of the same one sheet, i.e., in an integrated manner. According to embodiments, the limiter portion is configured to contact a housing part, e.g., at the side, i.e., perpendicularly to the axial direction, and to limit a radial deformation of the first and second conductor structure, especially when, due to the lengths compensation, the spring elements are compressed and radially deformed. This enables beneficially that the above-discussed contact force to the pin or sword is maintained independently of the axial movement. Moreover, the limiter portion may have the purpose to enable a preload for the contact at the sword.

As already discussed, the first and the second conductor structure may be formed out of one sheet, e.g., by bending, so that at the first side, there is a common layer. The common layer may comprise a stiffening structure, e.g., a corrugation. This stiffening structure enables beneficially that the structure of the electrical connector is maintained independently of the applied force.

According to embodiments, the first connector side comprises a plurality of springy contact elements extending from a common layer into a direction of the first connector side. The plurality of springy elements enables beneficially to electrically contact the first electrical element, e.g., a contact pad of the same. Due to the flexibility of the springy contact elements, the contact force is maintained.

According to embodiments, the springy contact elements are bent by more than 135° or bent by more than 150° or bent by 180° into the direction of the first connector side. The radius achieves (additional) flexibility of the springy contact elements. The springy elements enable to control the (minimum) contact force between the connector and the first electrical element.

According to a further embodiment, the first connector side comprises a plurality of decoupled contacts, especially decoupled contacts which may extend substantially perpendicularly to the first connector side. These decoupled contacts are configured to limit the pressure (contact force) on the plurality of springy contacts. Note the number and/or respective bent angle depend on the tension profile and force application. When the force on the springy contact elements is sufficiently large, the same are compressed so that the decoupled contacts get in contact with the first electrical element so as to beneficially limit the maximum force on the contact elements and the electrical contact pad of the first electrical element.

According to another embodiment, it might be possible that the first connector side comprises an additional spring element being arranged between the springy contact elements and a common layer formed by the connection of the first conductor structure and the second conductor structure.

According to embodiments, the connector, e.g., the connector comprising as minimum the first conductor structure and the second conductor structure, is formed by one sheet, especially one metal sheet or one coated metal sheet. According to embodiments, it is also possible that the springy contact elements are formed by the same sheet. Dependent on the cutting, the limiter portions can also be formed by the same sheet according to further embodiments. This is beneficial, since the number of components is significantly reduced, since the entire embodiment with some or all of the optional features can be formed by cutting the sheet and bending the sheet. This has significant advantages in the context of manufacturing.

Another embodiment provides a method for manufacturing the electrical connector. The method comprises cutting or, for example, stamping a metal sheet so as to form a first conductor structure and a second conductor structure (e.g., out of the one metal sheet); and bending the first conductor structure and the second conductor structure so as to form a first spring portion and a first contact wing out of the first conductor structure and to form a second spring portion and a second contact wing out of the second conductor structure.

### BRIEF DESCRIPTION OF THE DRAWINGS

Below, embodiments of the present invention will subsequently be discussed taking reference to the enclosed drawings, wherein

FIG. 1 shows a schematic illustration of an electrical connector for electrically interconnecting two electrical elements according to a basic embodiment;

FIG. 2 shows a schematic three-dimensional illustration of an electrical connector according to an enhanced embodiment to illustrate optional features;

FIG. 3A shows a schematic side view of the electrical connector of FIG. 2 in a compressed state of the flexible electrical connector (both sprig portions and flexible elements are compressed) to discuss enhanced embodiments;

FIG. 3B shows a schematic side view of the electrical connector of FIG. 2 in a non-compressed state of the flexible electrical connector (flexible elements compressed and sprig portion non-compressed) to discuss enhanced embodiments;

FIG. 3C shows a schematic enlarged view of a part (compressed) of the electrical connector of FIG. 3B to illustrate the contact using optional decoupled elements according to embodiments;

FIG. 3D shows a schematic side view of the electrical connector of FIG. 2 in a non-compressed state of the flexible electrical connector to discuss an only spring contact according to embodiments (both sprig portions and flexible elements are non-compressed);

FIG. 3E shows a schematic enlarged view of a part (non-compressed) of the electrical connector of FIG. 3D to further illustrate only spring contact according to embodiments;

FIG. 4 shows a schematic view of an electrical connector in an unfolded state i.e., before being bent according to embodiments;

FIGS. 5A/5B show schematically conventional connectors.

### DETAILED DESCRIPTION OF EMBODIMENTS

Below, embodiments of the present invention will be discussed taking reference to the figures, wherein identical reference numerals are provided to object having identical or similar function, so that the description thereof is mutually interchangeable.

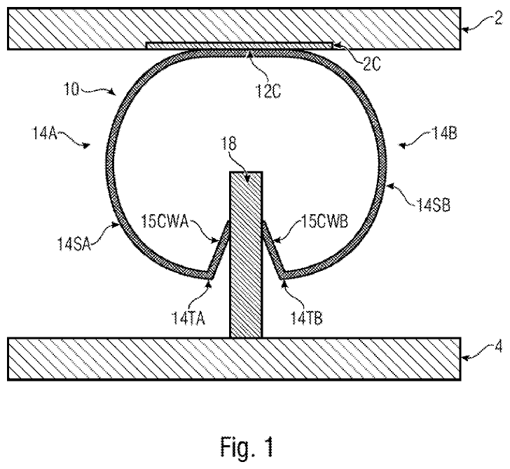

FIG. 1 shows an electrical connector 10 for electrically interconnecting a first electrical element 2 and a second electrical element 4. The first electrical element 2 may comprise a contact pad 2a. The second electrical element 4 comprises a kind of pin or sword 18, also referred to external pin or external sword to indicated that the pin or sword 18 is not part of the connector 10. The sword 18 might be a conductor. Due to thermal extension and/or tolerances the spacing between first electrical element 2 and the second electrical element 4 may vary.

The electrical connector 10 is arranged between the first electrical element 2 and a second electrical element 4 so as to connect or electrically connect the first electrical element 2 and a second electrical element 4. The connector 10 and comprises in the minimal configuration a first conductor structure 14A and a second conductor structure 14B. The first conductor structure 14A comprises a first sprig portion 14SA, wherein the second conductor structure 14B comprises a second spring portion 14SB. In the first conductor structure furthermore comprises a contact wing 15CWA, wherein the second conductor structure also comprises a second contact wing 15CWB. As can be seen, the first and the second contact wing 15CWA and 15CWB are a kind of continuation of the respective spring elements 14SA and 14SB.

Both spring elements 14SA and 14SB extend substantially in parallel or into the same direction from a first side, i.e., from the first electrical element 2, into a direction of a second side, i.e., to the direction of the second element 4. Preferably, spring elements 14SA and 14SB are curved, e.g., as illustrated. For example, the spring elements 14SA and 14SB may be curved to the inside having a radius. Note the spring elements 14SA and 14SB may act together due to the parallel arrangement. According to embodiments, the shape of the spring elements 14SA and 14SB may be different, e.g., so as to have a meander-shape or an s-shape or comparable shape, like a shape defined by a sequence of loops. The elements 14SA and 14SB are flexible and, starting from this flexibility, configured to provide length compensation between the first connector side 2 and the second connector side 4. For example, a compensation of ±0.5 mm or ±1 mm or in the range up to 5 mm might be possible. In other words, this means that the spring elements 14SA and 14SB allow flexibility in accommodating different distances or tolerances between the contact planes 2C and 4. This makes the design suitable for applications where physical movement or tolerance adjustments may be required.

As the end of the elements 14SA and 14SB a transition point 14TA and 14TB is arranged, where the wing elements 15CWA and 15CWB are further bent to the inside. For example, the wing elements 15CWA and 15CWB are bent into the direction of the element 2 so as to be arranged opposite to each other and configured to form a receptacle for the external sword 18.

Due to the geometry the contact wings 15CWA and 15CWB may—according to embodiments—be configured to provide a contact force to the sword 18. Due to the contact force a coupling between the contact wings 15CWA and 15CWB to the sword 18 is achieved. According to embodiments, this means that the structure includes integrated receptacles 15CWA and 15CWB that likely serve as the interface for connection and ensure that the contact pressure is maintained regardless of the assembly force. The receptacles might be part of the mechanism that decouples the contact pressure from the assembly force.

The transition points 14TA and 14TB are arranged on a second side of the electrical connector 10. On the first side opposite to the second side a contact area 12 is formed. Here, the connector 10 can be contacted to the contact pad 2C of the electrical element 2. The electrical component 2 may be the PCB board of an ECU, wherein 2C may be a contact pad of the PCB board 2.

Optionally, the contact area 12 may comprise flexible elements as will be discussed with respect to the below embodiments.

According to an embodiment the three portions 14SA, 12C, 14SB together with the two contact wings 15CWA and 15CWB may be integrally formed. For example, basis may be a metal sheet which is bent at the transition point 14TA and 14TB to form the two contact wings 15CWA and 15CWB and an along the radiuses of the spring elements 14SA and 14SB to form same. The two conductor structures 14A and 14B may have a further transition to the contact area 12C.

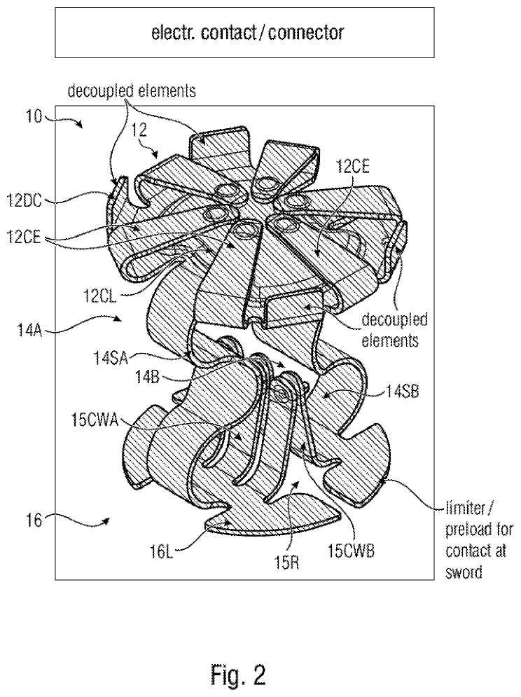

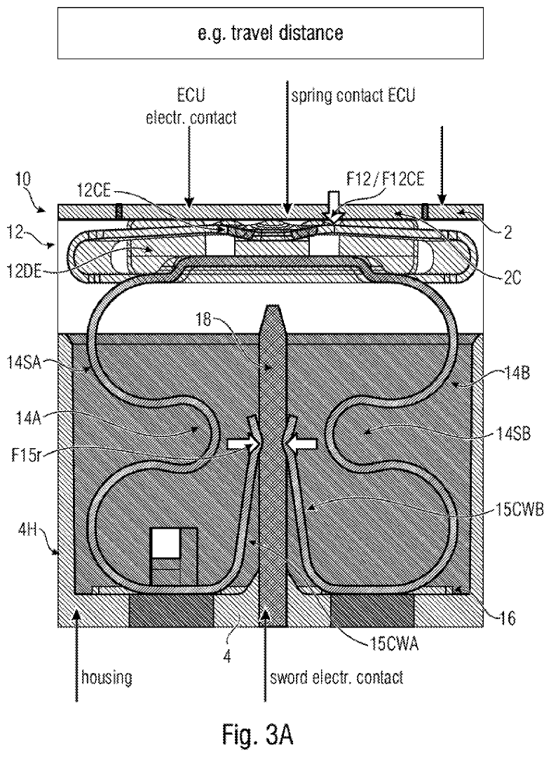

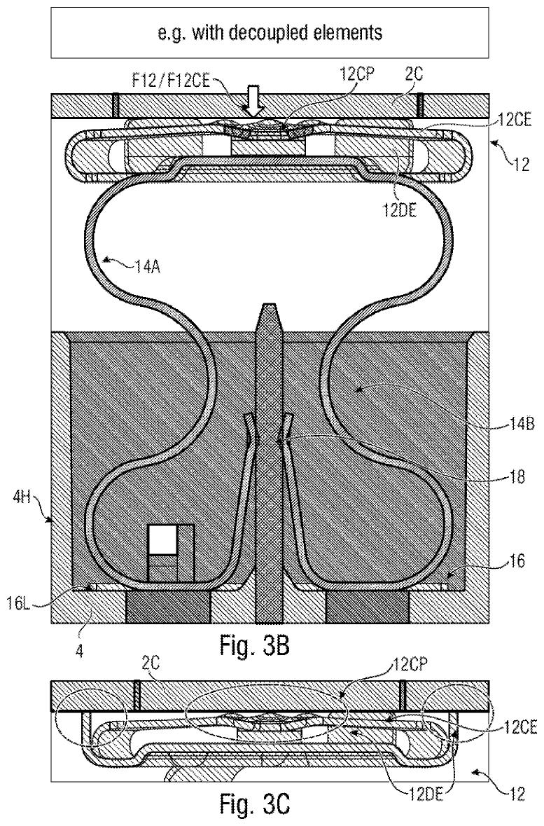

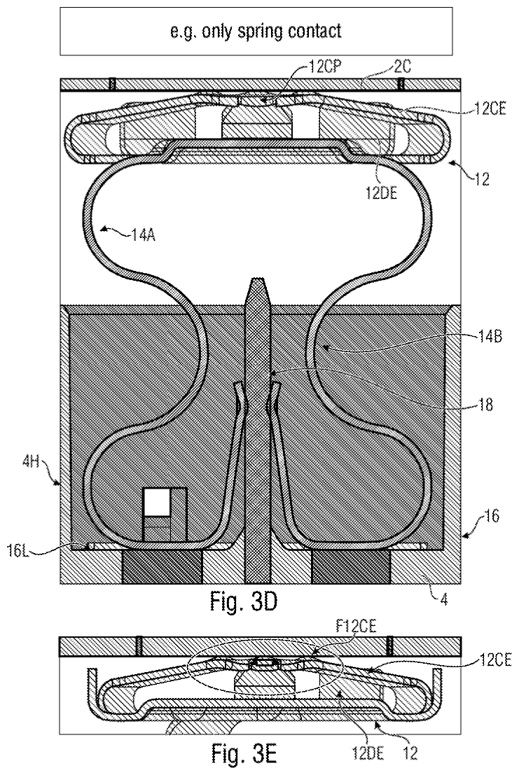

Since now the fundamental structure and the fundamental functionality has been discussed with respect to the integrally formed electrical connector 10, optional features and variants will be discussed taking reference to FIGS. 2, 3A, 3B, 3C, 3D and 3E.

With respect to FIG. 2 a further embodiment will be discussed. Here, some parts might be designed differently, wherein this fundamental function is comparable to the connector 10 of FIG. 1. Therefore, the same reference numerals are provided for the elements which are comparable so that the description thereof is mutually applicable and interchangeable.

FIG. 2 shows the electrical connector 10 comprising first connector side 12 and a second connector side 16 between the first connector side 12 and the second connector side 16, the conductor structures 14A and 14B, also referred to as first conductor structure 14A and second conductor structure 14B, extend. Each of the conductor structures 14A and 14B comprise the spring portions 14SA and 14SB and a respective contact wing 15CWA and 15CWB.

The contact wing 15CWA and 15CWB are formed as band portions being bent to the inside. Both elements 14SA and 14SB are arranged substantially in parallel. According to this embodiment the spring portions 14SA and 14SB have an s shape, here, for example, comprising one and a half s curves.

When seen from a side view, cf. FIG. 3A, the meander- or s-shaped spring elements 14SA and 14SB can be described as mirror-inverted geometries so that 14SA and 14SB together have a shape of a butterfly. In other words, this means that the connector 10 consists of several curved, spring-like components that likely serve to provide contact pressure both into the axial direction and perpendicular to the axial direction, namely to the sword 18 as already discussed above. The axial force is marked by F12, the contact force on the sward 18 is marked by F15r in FIG. 3A.

According to embodiments, the two spring elements 14A and 14B may be connected to each other on the first side to form a common layer 12CL. From this common layer 12CL, the spring elements 14A and 14B extend into a direction of the second connector side 12.

According to embodiments, the first connector side 12a comprises a plurality of contact elements 12CE which are arranged so as to extend into a direction of the first connector side, i.e., to the element 2. These contact elements 12CE might be flexible and, thus, are referred to as springy contact elements 12CE. Same may be attached to or extend from the common layer 12CL and may be bent approximately 180° so as to form the contact point 12Cp for the first electrical element 2 (cf. FIG. 1). These springy elements 12CE are flexible so as to provide or control the contact force to the contact pad 2. The resulting contact force is marked by F12CE in FIGS. 3A and 3B.

It should be noted that the number of springy contact elements 12C may vary. Here, six springy contact elements 12CE together with four decoupling elements 12DE are shown. According to further embodiments, two or three or four springy contact elements or a completely different number may be possible as well.

According to further embodiments, additional decoupling elements 12dc may optionally extend from the common layer 12C into the first direction. The decoupling elements may, for example, extend substantially perpendicular into the direction of the first side and are configured to limit spring travel of the springy contact elements 12CE and, thus, the (maximum) contact force. These decoupling elements 12dc may be arranged to contact the first electrical element in an area abutting the contact pad of the electrical element. In other words: In doing so, the springy contact elements 12CE enable beneficially to maintain a contact force F12 to the first electrical element, wherein the decoupled elements 12dc enable that the contact pressure is limited and decoupled from the actual force, especially the assembly force during the assembly phase. Consequently, the contact pressure on the ESU (electronic control unit) is decoupled from the actual assembly force. This means that the force applied during assembly does not directly affect the electrical contact pressure, which is beneficial for ensuring reliability and performance over the time, even if the assembly tolerances vary.

For example, the force may be limited to approximately 30 newton or 34 newton (general in the range between 10 and 50 N), wherein the springy contact elements 12CE ensure a minimum contact force of, e.g., 10 newton or 15 newton general in the range between 5 and 20 N. It should be noted that the force is typically dependent from the selected material and the thickness of the bent sheet.

According to embodiments the connector might have a cylindrical shape. For example, the connector may be guided by a housing 4H having a cylindrical block. This is shown by FIGS. 3A, 3B and 3D.

As already mentioned above, the two wing elements 15CWA and 15CWB are bent and facing each other so that they form a receptacle 15r for an external sword 18. The structure includes integrated receptacles that likely serve as the interfaces for connection, ensuring that the contact pressure is maintained regardless of the assembly force. Due to the elastic bending they are configured to apply a contact force f15r to the external sword. This contact force F15r as illustrated by FIG. 3A is independent from the axial compensation and/or an assembly force.

According to further embodiments, a plurality of contact wings 15CWA and 15CWB on each side may be used. In FIG. 2 three contact wings 15CWA and 15CWB are shown on each side. The plurality of contact wings 15CWA are facing to the plurality of contact wings 15CWB so that the sword can be fixed due to the force F15r as shown by FIG. 3A, FIG. 3B or FIG. 3D.

According to embodiments, the two conductor structures 14A and 14B may comprise a limiter 16L arranged in the area of the transition point 14TA and 14TB. The limiter can comprise a plurality, here four circle segments which can be contacted to a housing 4H so as to support the contact force F15r. The contact between the limiter 16L and the housing 4H is illustrated by FIGS. 3A, 3B and 3D. Due to the support of the limiter 16L the contact force is maintained even if the spring elements 14A and 14B are compressed in a manner so that the two spring elements 14A and 14B might spread open. Additionally, the limiter portion 16L may have the purpose to enable a preload for the contact at the sword 18.

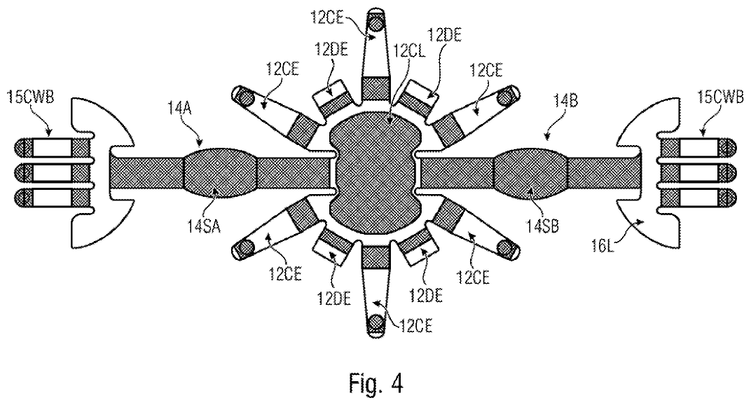

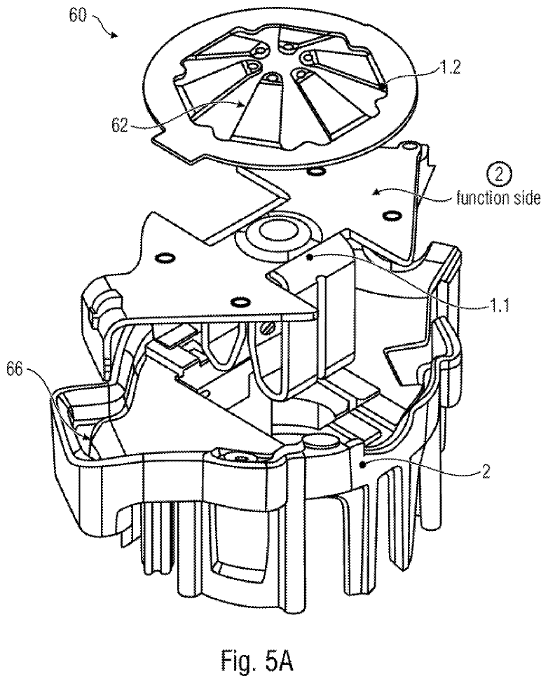

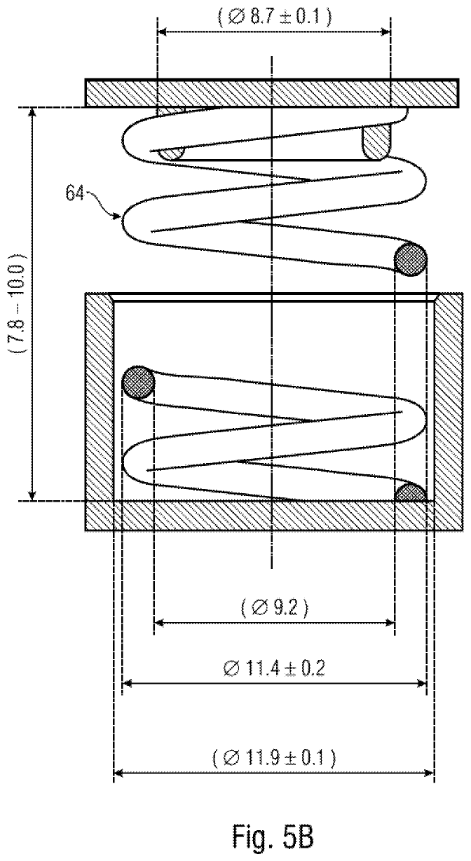

As can be seen by FIG. 4, the limiter 16L has a round shape where the diameter is adapted to the bore of the housing 4H. In case, the housing has a different shape, e.g., a square shape or another shape, the shape of the limiter 16L may vary as well.

It should be noted that the force F15r is perpendicular to the axial direction of the connector 10, while the force F12 and F12CE acts substantially in parallel to the axial direction of the connector 10.

Stating from the above discussed structure, different states (compressed/non compressed state) of the connector 10 as shown by FIG. 3A to 3D will be discussed.

FIG. 3A shows the electric connector 10 being compressed between the first electrical element (cf. first connector side 12) and the second electrical element (cf. a second connector side 16), wherein FIG. 3b shows the same connector 10, where the connector 10 is stretched or not compressed. As can be seen, due to the axial displacement the “butterfly”-like shape of the spring-like components 14SA and 14SB may slightly vary without influencing any contact force F15r, F12 or F12CE. Note the force F15r referrers to the force at the contact points between the sword 18 and the wing elements 15CWA and 15CWB are comparable to each other. The force F12CE is the force at the contact 12CP between the element 2C and the contact element 12CE and results mainly from the compression of the elements 12CE. F12 is the axial force which reacts on the two spring elements 14A and 14B having the purpose to provide length compensation. This makes the design suitable for applications where physical movement or tolerance adjustments are required.

As can be seen with respect to FIG. 3C, the contact force F12CE is limited since the decoupling elements 12DE are in contact with the component 2 so that the springy contact elements 12CE are not further bent.

FIGS. 3D and 3E illustrate the situation where axial force is further reduced. Here, the contact 12CP is still maintained due to the spin force of the springy contact elements 12CE. The background thereof is that the decoupling elements 12DE are not in contact with the component 2 anymore. In a result, just the contact between 12CE and 2C is maintained. Expressed in other words this means that the springy contact elements 12CE ensure the contact to the element 2C.

As already mentioned above, the electrical contact 10 is made from a single piece of stamped metal. This metal before bending is shown by FIG. 4. FIG. 4 shows the connector 10 including the elements 12, 12DE, 12CE, 12CL, 14A, 14SA, 14B, 14SB, 15CWA, 15CWB and 16L. The shape indicates that it was created using a stamping process from a grid, which helps reduce manufacturing complexity while ensuring precision. As can be seen, all these elements are arranged side by side before bending it to a 3D component. Preferably, the sheet is a metal sheet, like steel or spring steel or copper, so that a conduction from the one side to the other side is possible. According to embodiments it is possible that the sheet may be coated, e.g., by silver, so as to increase the conduction properties. The selection of a material or especially of the coating may be dependent on the material pairing to the contacts 2C or the sword 18.

According to embodiments, the diameter of the connector is around 10 mm or 30 mm, in general between 5 mm and 15 mm or 5 mm and 20 mm or 5 mm and 50 mm according to embodiments. The height might be approximately 10 mm or 14 mm or in general in a range between 5 mm and 15 mm, 5 mm and 20 mm or 5 mm and 50 mm. Of course, the size depends on the application.

As can be seen by FIG. 4, the spring portions 14SA and 14SB are formed by a stripe of bent metal. The stripe may have a continuous width or a width which varies. Here, the width in the middle is increased so as to optimize the elastic properties.

The shape indicates that it was created using a stamping process from a grid which helps to reduce the manufacturing complexity while ensuring precision. All radiuses are marked by the hatches.

According to a further embodiment, an additional spring, e.g., having meander shape may be arranged. In this case, the portion between the first conductor structure and the second conductor structure and the common layer 12CL may be arranged which can be folded to a meander so as to provide additional spring force and especially additional displacement distance.

According to embodiments, this type of connector could be used in automotive or industrial electronics which reliable connections are necessary despite large mechanical tolerances or movement. The design allows for compensating varying distance between the contact planes which is particularly useful in environments subjected to vibrations, thermal expansions or other mechanical stresses. The overall desire enables to achieve consistent electrical contact in applications where mechanical tolerances vary or are difficult to control. It should be noted that, according to embodiments, the electrical connector may be arranged between two elements, like an ECU and a motor, wherein the bore of the housing 4H may be filled by a fluid, like oil.

According to an embodiment the connector 10 is implemented as punched part clamped in the phase ring and connected to the blade 18 and control unit 2.

Another embodiment provides a method for manufacturing the connector 10. It comprises the two main steps of stamping the sheet and bending the field so as to achieve the above discussed design. As mentioned, the radiuses or the bent portions are hatched in FIG. 4.

Note a description of a features discussed in context of an apparatus represent also a description of a corresponding method step and vice versa. Above embodiments have illustrative purpose, wherein the scope of protection is defined by the following claims.

What is claimed is:

1. An electrical connector for electrically interconnecting a first electrical element and a second electrical element, the electrical connector extending from a first connector side to a second connector side, the electrical connector comprising:
a first conductor structure comprising a first spring portion and a first contact wing; and
a second conductor structure comprising a second spring portion and a second contact wing, wherein the first spring portion and the second spring portion are configured to provide length compensation between the first connector side and the second connector side, and wherein the first contact wing and the second contact wing are arranged opposite to each other and configured to form a receptacle for an external pin or sword of the second electrical element.

2. The electrical connector according to claim 1, wherein the first conductor structure and the second conductor structure are integrally formed.

3. The electrical connector according to claim 1, wherein the first conductor structure and the second conductor structure are arranged substantially in parallel with each other.

4. The electrical connector according to claim 1, wherein the first spring portion and the spring portion have a meander-shape or s-shape or shape defined by a sequence of loops.

5. The electrical connector according to claim 1, wherein the first contact wing and the second contact wing are bent to an inside and/or are continuations of the first spring portion and the second spring portion being bent to the inside.

6. The electrical connector according to claim 1, wherein the first contact wing and the second contact wing are configured to provide a contact force to the pin or the sword of the second electrical element.

7. The electrical connector according to claim 1, wherein each of the first contact wing and/or the second contact wing comprise a plurality of wing parts.

8. The electrical connector according to claim 1, wherein the second connector side comprises a limiter portion configured to contact a housing part and to limit a radial deformation of the first conductor structure and the second conductor structure.

9. The electrical connector according to claim 1, wherein the first conductor structure and the second conductor structure are connected to each other so as to form a common layer at a first side.

10. The electrical connector according to claim 9, wherein the first conductor structure and the second conductor structure extend from the common layer into a direction of a second side; and/or wherein the common layer comprises a stiffening structure.

11. The electrical connector according to claim 1, wherein the first connector side comprises a plurality of springy contact elements extending from a common layer into a direction of the first connector side.

12. The electrical connector according to claim 11, wherein the plurality of springy contact elements are bent by more than 135 degrees into the direction of the first connector side.

13. The electrical connector according to claim 11, wherein the first connector side comprises a plurality of decoupled contacts which extend substantially perpendicular to the first connector side and/or configured to limit a pressure on the plurality of springy contact elements; and/or wherein the first connector side comprises an additional spring element being arranged between the springy contact elements and a common layer formed by a connection of the first conductor structure and the second conductor structure.

14. The electrical connector according to claim 1, wherein the connector is formed by one sheet.

15. A method for manufacturing the electrical connector, the method comprising:
cutting a metal sheet so as to form a first conductor structure and a second conductor structure;
bending the first conductor structure and the second conductor structure so as to form a first spring portion and a first contact wing out of the first conductor structure and to form a second spring portion and a second contact wing out of the second conductor structure.
